(19) United States
(12) Patent Application Publication
(10) Pub. No.: US 2004/0046781 A1
(43) Pub. Date: Mar. 11, 2004

(54) Movie description language

(75) Inventor: Vivek S. Nittoor, Bangalore (IN)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/234,139

(22) Filed: Sep. 5, 2002

(51) Int. Cl. G09G 5/00

(52) U.S. Cl. 345/723; 345/730

(57) ABSTRACT

A movie description language which enables objects and the corresponding transformation rules to be specified, and a corresponding movie to be played. An object may be specified by attributes such as shape, size, color, location, illumination, texture. Transformation rules specify change of any of the attributes on a time scale (including frame count). In addition, many instances of an object may be instantiated with different transformation rules. A real time video rendering device receives the movie data (including instance/object definitions and transformation rules) and plays the corresponding movie.

### BACKGROUND OF THE INVENTION

1. Field of the Invention

The present invention relates to computer graphics, and more specifically to an efficient method and apparatus to specify the images in a movie.

2. Related Art

Movies are generally played by displaying successive image frames with short inter-frame time gap as is well known in the relevant arts. Various types of display screens (e.g., computer monitors, television screens, cell phone displays, movie screens) are used to display the image frames at high refresh rates. For example, in a typical movie displayed in a movie theater, images are refreshed at a pre-specified number of frames/second.

Often each image frame is displayed based on a corresponding digital representation. For example, each image frame may be represented by a certain number of pixel data elements in the X and Y-directions, and an image frame may be refreshed/displayed according to the pixel data elements.

A prior technology may allow for storing (or reception in real-time over a network) of the pixel data elements forming successive frames, and a display screen may be refreshed based on the received data elements. One problem with such an approach is that the storage (or transmission bandwidth requirements) requirements may be unacceptably high due to the large number of frames, and potentially a large number of pixels within each frame for high resolution images.

Other prior approaches may compress the data representing the image frames using various techniques. The compression approaches are some times based on data within the same frame and some times based on data in different frames. In either approach, the stored or transmitted data generally represents the individual frames or the content of the frames which can be manually edited by a user. Examples of such approaches are described in a standard entitled MPEG-4, available at the following URL (and at many other places on the world-wide web), and is incorporated in its entirety into the present application herewith: http://mpeg.telecomitalialab.com/standards/mpeg-4/mpeg-4.htm

One problem with such approaches is that the amount of data required to represent a movie even with compression, might be large. The high volume of data may be undesirable, for example, due to the storage requirements and/or bandwidth requirements for transmission. Accordingly, what is required is a method and apparatus which enables a movie to be represented while minimizing the data (storage/transmission) requirements.

### SUMMARY OF THE INVENTION

A movie generator according to an aspect of the present invention generates a movie data representing a movie. The movie data may specify multiple attributes defining each object in the movie, and also transformation rules associated with each object. Each transformation rule indicates a change of an object attribute.

A video rendering system may receive the movie data and generate scenes according to the attributes of the objects and the multiple transformation rules. The scenes are then used to generate displays on a display screen to play the movie. As the movie is defined in terms of objects and transformation rules, the amount of data required to represent a movie may be reduced.

In an embodiment, the movie data specifies a slice plane, and the scenes are generated according to the slice plane. A transformation rule may be associated with the slice plane also. The transformation rule, may specify, for example that the slice plane is to be moved from one position to another. The scenes are generated according to the present slice plane after effecting the applicable transformation rules.

The video rendering system may be implemented using various approaches. In an embodiment, a pre-processing block is used to compile the movie data to generate an intermediate data, and the intermediate data is used to generate the scenes. The intermediate data may represent a specific set of objects forming a specific scene according to the slice plane.

According to another aspect, an object may be instantiated multiple times, and specific transformation rules may be associated with each resulting instance.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. 1 is a block diagram illustrating an example environment in which the present invention can be implemented;

FIG. 2 is a flow-chart illustrating a method in accordance with the present invention;

FIG. 3 is a block diagram illustrating the details of a real-time video rendering system in an embodiment of the present invention; and

FIG. 4 is a block diagram illustrating the implementations substantially in the form of software instructions.

### DETAILED DESCRIPTION OF THE PREFERRED EMBODIMENTS

1. Overview and Discussion of the Invention

A movie description language provided according to an aspect of the present invention enables the behavior of various objects (persons, things, etc.) to be specified by various transformation rules, and a decoder generates image frames representing various scenes (forming a movie) according to the transformation rules and the attributes of the various objects.

A slice plane for viewing may also be specified and the scene content may be generated according to the slice plane. Transformation rules may also be associated with the slice plane such that the image frames are generated to correspond to the view according to the slice plane changing according to the transformation rules.

As an illustration, a two lane road (an object) may be specified with various attributes (color, shape, etc.). The road may be modeled potentially as a static object which does not change. Flowers may be defined along the road side, with transformation rules indicating how the flowers move and blossom. A first car may be defined with transformation rules to move/drive in one lane and a second car may be defined with transformation rules to move/drive in the second lane.

A slice plane may be defined to correspond to a hypothetical plane viewed (from an eye) by a driver in the first car. Once all the objects and their corresponding transformation rules are defined, image frames representing scenes may be generated based on the definition of the objects, definition of the slice plane and the transformation rules.

While the above description is provided as if each object is used in a single instance, multiple instances of an object may be instantiated potentially with different transformation rules. For illustration, in the above example, an object defined as a flower may be instantiated multiple times with different transformation rules to appear as several different flowers on the road side.

The invention is described herein with reference to several examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

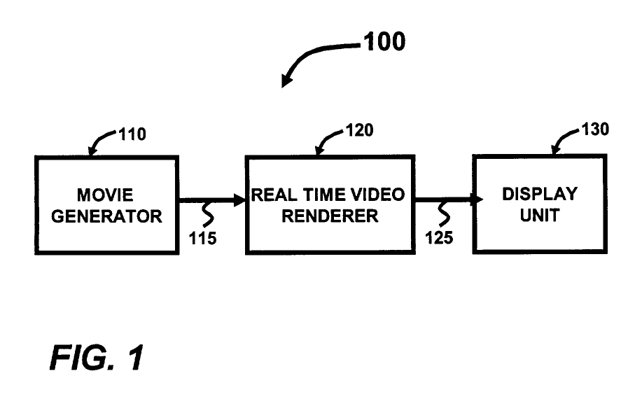

FIG. 1 is a block diagram illustrating the details of an example environment in which several aspects of the present invention can be implemented. The environment is shown containing movie generator 110, real time video renderer (RTVR) 120, and display unit 130. Each system is described below.

Movie generator 110 generates movie data representing the details of various objects according to a movie description language (MDL). The MDL enables a designer to specify various attributes (shape, color, texture, illumination, etc.) of the objects. In addition, the MDL may enable the designer to specify the time at which an object is to be instantiated, and the transformation rules associated with the instance. The transformation rules may be specified associated with an object itself, in which case the instance inherits the specified transformation rule. Additional transformation rules may be specified (including potentially modifying/deleting the rules associated with the object) the associated with each instance.

Real time video renderer (RTVR) 120 receives movie data on path 115, and generates display signals on path 125 representing the movie to be played. RTVR 120 generally needs to be implemented consistent with the MDL using which the movie has been earlier specified. Data representing the scenes are generated from movie data. RTVR 120 then sends display signals causing display unit 130 to display the images represented by the scenes. The movie data may further include audio information, which may be encoded (in movie generator 110), received and played in a known way.

Display unit 130 receives display signals representing image frames on path 125 and displays the image frames causing the (visual component of) movie to be played. Display unit 130 may be implemented in a known way. The description is continued with reference to a general method using which movies may be generated using a MDL provided according to various aspects of the present invention.

3. Method

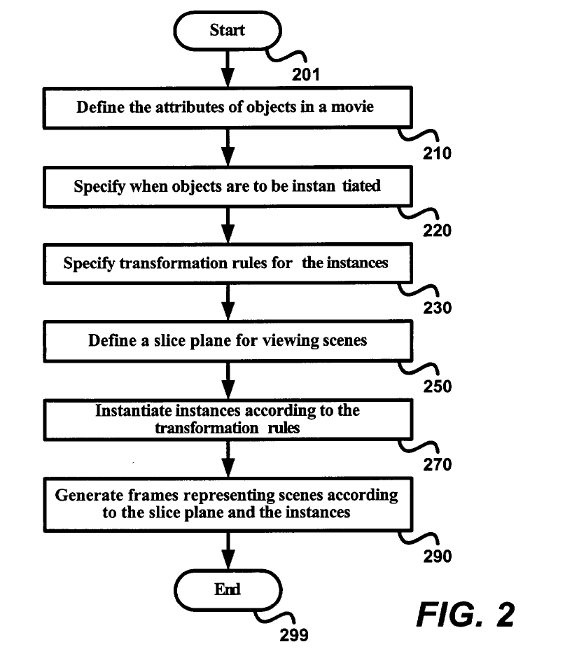

FIG. 2 is a flow chart illustrating a method according to an aspect of the present invention. The method is described with reference to the systems of FIG. 1 for illustration. However, the method can be implemented in other environments as well. The method begins in step 201, in which control immediately passes to step 210.

In step 210, a designer defines various attributes (size, location, shape, color, illumination, etc.) of objects in a movie. In general, at least the portions (internal or external) of each object that are visible need to be generally defined. For example, the visible portions may be described in terms of various object attributes such as shape, colors, and textures.

In step 220, the specific time at which each object is to be instantiated, may be specified. Multiple instances of an object may be created as necessitated by the eventual movie sought to be played.

In step 230, a designer may specify transformation rules for the instances. A transformation rule generally defines the manner in which an object changes over time. For example, a transformation rule associated with a car may specify that the car is moving at a speed of 30 MPH on a road. A transformation rule can affect aspects such as location and various attributes of the corresponding instance.

In step 250, a designer may also define a slice plane for viewing scenes. In general, a slice plane represents a plane or reference which is viewed by a human eye. In addition, a designer may specify transformation rules associated with a slice plane as well. For example, the slice plane may be shifted from one car to another car being driven on a two lane road at specific instances of time.

All the above steps (210, 220, 230 and 250) may be performed in movie generator 110. The resulting movie data is then sent (either by storage medium or transmission) to RTVR 120, which plays the movies as described below based on the movie data.

In step 270, the object instances are instantiated at a corresponding time specified by the movie data. The location and attributes of the instances may change according to the associated transformation rules. In general, an instance has existence for a specified duration of time only. The transformation rules for each instance may be specified on a relative time scale (or number of scenes), and the instance may be transformed accordingly once instantiated.

In step 290, the data representing various scenes is generated. In general, a scene is defined by mapping the various instances onto a slice plane as is well known in the relevant arts. Even if the objects are not transformed, the displayed scene may change if the slice plane is changed according to the associated transformation rule. Image frames are generated based on the scene, and display screens may be refreshed based on the generated image frames. The method ends in step 299.

From the above, it may be appreciated that both movie generator 110 and RTVR device 120 need to be implemented consistent with a movie description language (MDL). An example MDL is described below for illustration. However, the implementation of various alternative embodiments of MDL will be apparent to one skilled in the relevant arts based on the disclosure provided herein. Such other embodiments are contemplated to be within the scope and spirit of various aspects of the present invention.

4. Movie Description Language (MDL)

In an embodiment, MDL supports many features as in object oriented programming languages (for example, C++), which provides standard set of class libraries containing several objects. However, the user may be provided the flexibility of defining new classes/objects, or deriving new classes from existing classes (inheritance feature). The inheritance feature enables a designer to add extra description to the existing classes to represent an object instead of writing complete description about the object.

MDL may be used to represent objects in three-dimensions (3D). A 3D object can be defined in terms of surfaces and their interactions. For example, a cube may be defined with six surfaces and the six surfaces interact (e.g., join or connect) to form a cube. Each surface may in turn be defined by more primitive shapes such as trapezoids and triangles in a known way. The MDL (syntax and grammar) needs to enable a user (designer) to specify when an object is to be instantiated. The point of time the instance is to be instantiated may be specified on a relative time scale (e.g., 10.3 seconds from the start of the movies) or number of frames.

The MDL may need to enable a user to specify the transformation rules associated with an object. The transformation rules specify the manner in which the attributes (including location) of an instance change over time. Transformation rules may be associated with actions such as talking, laughing and eye-blinking. One may analyze the manner in which human parts (points on each part) move for a corresponding action, and model the changes as implementing the corresponding transformation rule. Such an approach is particularly useful in creating synthetic objects.

The transformation rules may provide the flexibility of specifying repetitive actions. For example, a rule may simply need to specify that eyes need to blink at a random interval with a mean of 1.5 seconds, and the pixels forming eyes should be modeled to blink with an approximate interval of 1.5 seconds. Similarly, the movement of body parts can be examined and modeled to enable transformation rules to specify actions such as walking and laughing.

The MDL may further need to specify a slice plane, which represents a logical plane viewed by a viewer, as noted above. The slice plane may be defined with respect to the 3D absolute co-ordinate system and the bounding dimensions of display screen. Similar to transformation rules on 3D objects, slice plane can also be transformed in any arbitrary fashion on a time scale (of number of frames). Once the slice plane is known, the scenes may be generated using one of several known approaches. In general, the 3D instances are mapped onto the slice plane (in two dimensions) to generate a scene.

The scenes may change according to the transformation rules of various instances, when generated for viewing. The 3D object may change its dimensions and orientations with respect to the slice plane in consecutive frames. The dimensions and orientations of a graphic object in a three dimensional space may be specified with transformation rules in the Movie data. According to the transformation rules, the orientation and structure of 3D objects can be changed from frame to frame if necessary.

In an embodiment, each frame/scene in a movie contains a list of objects and their movements in a three dimensional space. The motion/transformation rules for objects for consecutive frames are specified in Movie data. The consecutive frames can be constructed by rendering the graphic objects on a display unit in an order specified by the movie data. An object can be added or deleted from any particular frame by simply modifying the movie data.

From the above, it may be appreciated that an MDL may be implemented as a high level, device independent descriptive language for digital transmission, storage of real time video. MDL may be used for generating synthetic graphics, creating animation movies, etc. In addition to generating/creating movies, MDL may provide for substantial reduction in storage/transmission requirements by representing consecutive frames in terms of objects and transformation rules. Example 3D objects represented with MDL are described below for illustration.

5. Examples

The manner in which an object and associated transformation rules can be defined is described below with reference to two examples for illustration. In a first example, a cube is defined as an intersection of six 2D surfaces (S1, S2, S3, S4, S5 and S6). The MDL program defining the cube is described below.

/define cube(1) {

/startsurface

/surface S1={x, y, z/x=0}

/surface S2={x, y, z/y=0}

/surface S3={x, y, z/z=0}

/surface S4={x, y, z/x=1}

/surface S5={x, y, z y=1}

/surface S6={x, y, z/z=1}

/intersect}

MDL primitives used in above MDL program for defining a cube are ‘/define’, ‘/startsurface’, ‘/surface’ and ‘/intersect’. The primitive ‘/define’ defines an object with the name specified as a parameter to it. In this case, the parameter is cube and so the object name is conveniently chosen as ‘cube’. The variable 1 within brackets of ‘cube(1)’ specifies the length of each side of the cube.

The primitive ‘/startsurface’ resets the surface history and starts the definition of a new object. The primitive ‘/surface’ represents each surface of a cube in a two dimensional space. The primitive ‘/intersect’ causes all the surfaces defined between /startsurface and /intersect to intersect, thereby defining the object (cube) as one entity.

The next step after defining an object (cube), is to specify code which instantiates an instance of the defined object, and defines/applies transformation rules on the instance (cube in the above example). In addition, the slice plane needs to be defined as well. The manner in which the example MDL may perform such tasks is described below.

/startframe

X cube(2); X is defined to be a cube of length 2

/translationrule x=0, y-5t, z=0; movement of object along y

/sliceplane sp={x=0}

/sliceplanetranslationrule x=0, y=0, z=0; no movement

/endframe 43; takes 43 as a parameter representing the number of frames

The MDL program above uses the primitives ‘/startframe’ and ‘/endframe’ which respectively represent the start and end of the scenes defined by the portion of the MDL code. The primitive ‘/endframe’ accepts a number (43 in the example above) as an argument which represents the number of consecutive frames/scenes in which the instantiated objects are rendered according to the transformation rules from the start frame.

Thus, when the scenes are rendered to display a movie, the object (cube) is instantiated as ‘X’ with a length of 2, corresponding to the passed parameter value. The primitive ‘/translationrule’ causes the object (cube) to move along y-axis. While the corresponding motion is linear, other types of motions suitable for the specific objects may be defined.

The slice plane (2D plane to view the object from) is defined and its translation rule (no movement) is applied respectively with primitives/sliceplane and /sliceplanetranslationrule. The slice is plane is defined stationary, even though the position can change over time or at a specific time point. The object cube is instantiated and is moved along y-axis for each frame to be rendered till the end of the frame (43^{rd} frame). As a result, the movie that is rendered can be viewed as a cube moving on the screen.

Similarly, a sphere can be defined as a closed surface and the MDL program for defining the sphere with radius ‘2’ and origin at (0, 0, 0) is described below.

/define sphere(r) {; ‘r’ represents the radius

/start surface

/surface S1={x, y, z/x\hat{ }2+y\hat{ }2+z\hat{ }2=r\hat{ }2}; sphere representation where ‘\hat{ }’ denotes power of

/intersect}

Next step after defining the object (sphere) is to instantiate and transform the objects and/or slice plane. The manner in which the step(s) can be attained with the example MDL, is described below.

/startframe

X sphere(2); X is defined to be a sphere of radius 2

/translationrule x=0, y=5t, z=0; movement of object along y

/sliceplane sp={x=0}

/sliceplanetranslationrule x=0, y=0, z=0; no movement

/endframe 43; takes 43 as a parameter representing the number of frames

Similar to cube, from the above MDL program, the movie would display a-sphere moving across the screen. For illustration, MDL program is described with objects cube and sphere, however the approaches can be used to any represent/define and transform more complex objects (e.g., animals, human beings, animation characters). The movie data thus generated is sent to RTVR 120 for playing the corresponding movie. An example implementation of RTVR 120 which displays the movie on display unit 130 is described below in detail.

6. Real Time Video Render

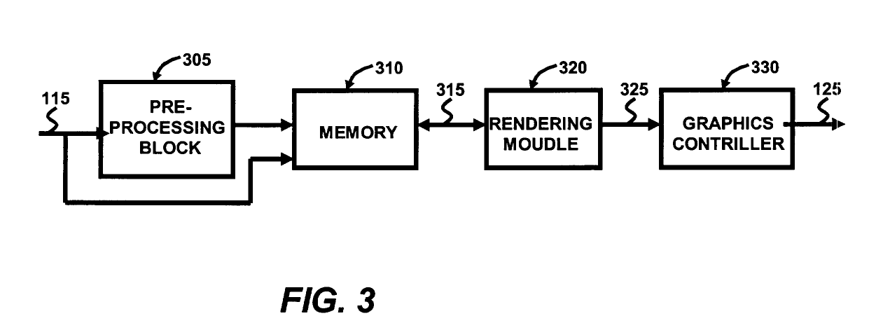

FIG. 3 is a block diagram illustrating the details of an example implementation of RTVR 120. RTVR 120 receives the movie data representing the object to be rendered and generates the image frames that are to be displayed on screen. RTVR 120 is shown containing pre-processing block 305, memory 310, rendering module 320 and graphics controller 330. Each component is described below.

Pre-processing block 305 receives movie data on path 115, and performs any preprocessing tasks necessary for the operation of rendering module 320. The output generated by pre-processing block 305 may be stored in memory 310. Due to the operation of preprocessing block 305, the examination overhead may be reduced in the subsequent components in RTVR 120.

In an embodiment, pre-processing block 305 examines the entire movie data to generate intermediate data reflecting the specific objects to be contained in each scene, the specific slice plane for each scene, etc. The processing may be performed off-line (i.e., not real time), and the processing may be referred to as compilation. In such a situation, processing block 305 may be located external to RTVR 120.

Memory 310 may receive all or portions of movie data on path 115 and stores the received data. For example, the attributes of various objects may be received directly from path 115 and stored in memory 310. In addition, memory 310 may store the intermediate data generated by pre-processing block 305. Alternatively, if rendering module can interpret the movie data in real time and play a movie, the movie data can be stored in memory 310 without any/substantial pre-processing.

Rendering module 320 generates scenes according to the movie data received on path 115. In one embodiment, rendering module 320 operates as an interpreter, in which case the movie data may be presented via memory 310 substantially in the same form as that received on path 115.

Alternatively, intermediate code (generated, for example, by compilation) may be received on path 315, and the intermediate code can be used to generate the scenes. The task of generating the image frames is simplified in the compilation approach since all the necessary data (including the specific objects which will appear in the scene, the slice plane and the applicable transformation rules) may be readily available for each scene based on the earlier compilation.

A combination of the two approaches noted above can be used as well. Each scene, thus generated, contains several pixels represented by corresponding values (pixel values), and the pixel values are passed to graphics controller 330.

Graphics controller 330 receives pixel values representing image frames (scenes), and generates the display signals on path 125 causing the corresponding images to be displayed on display unit 130. Graphics controller 330 can be implemented in a known way.

From the above, it may be appreciated that RTVR 120 may receive movie data and play the corresponding movie. Movie generator 110 generates the movie data. An example embodiment of movie generator 110 is implemented substantially in the form of software. Similarly, RTVR 120 can also be implemented substantially in the form of software as also described below. In general, either system can be implemented as a combination of one or more of hardware, software and firmware. In general, when cost is of primary concern, the implementation is performed more in software. On the other hand when performance is of primary consideration, the implementation may be performed in hardware.

7. Software Implementations

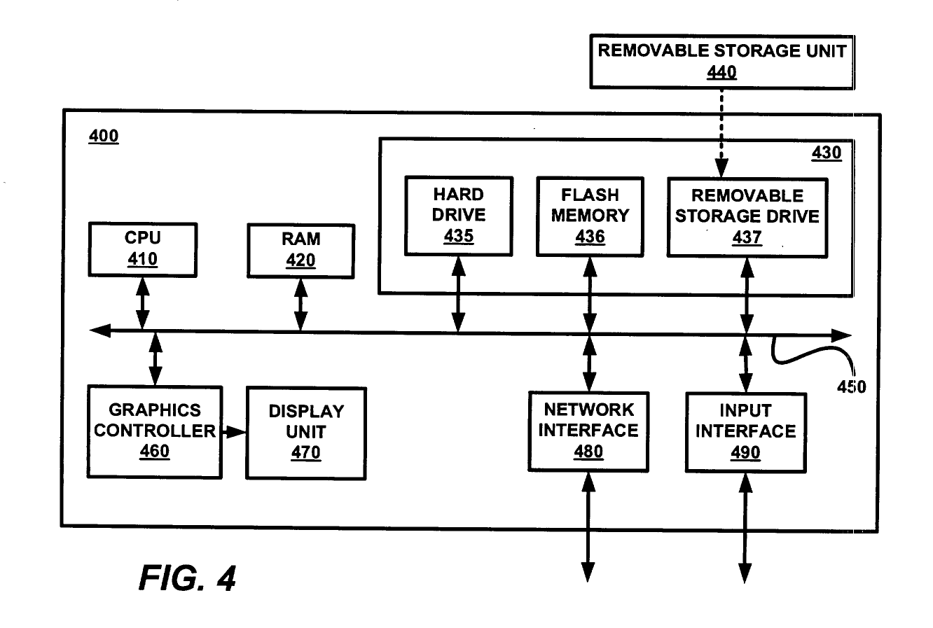

FIG. 4 is a block diagram of system 400 illustrating the details of an embodiment of the present invention implemented substantially in the form of software. Computer system 400 may correspond to either movie generator 110 and/or RTVR 120 as described below. Computer system 400 may contain one or more processors such as central processing unit (CPU) 410, random access memory (RAM) 420, secondary memory 430, graphics controller 460, display unit 470, network interface 480, and input interface 490.

All the components except display unit 470 may communicate with each other over communication path 450, which may contain several buses as is well known in the relevant arts. The components of FIG. 4 are described below in further detail.

Input interface 490 may correspond to apparatus such as a key-board and/or a mouse, which enables a user to provide input in various forms. In the case of movie generator 110, input interface 490 enables a designer to develop movie data. Thus, a user may use input interface 490 to specify various objects (including attributes) and the transformation rules. A combination of both textual and graphical approaches may be enabled to define the objects and to specify the transformation rules, even though only textual approach is described above.

Display unit 470 may aid input interface 490 in enabling the user to specify the objects. The movie data may be stored in RAM 420 or in secondary memory 430 for further processing or later transmission in case system 400 corresponds to movie generator 110. In the case of RTVR 120, input interface 490 enables a viewer to start/stop/pause a movie, and display unit 470 corresponds to display unit 130.

Network interface 480 may be implemented consistent with protocols such as ATM and Internet Protocol. Network interface 480 causes movie data to be transmitted in case system 400 corresponds to a movie generator and the movie data to be received in case system 400 corresponds to a RTVR. Input interface 490, network interface, and display unit 470 may be implemented in a known way.

Secondary memory 430 may contain hard drive 435, flash memory 436 and removable storage drive 437. Flash memory 436 (and/or hard drive 435) may store the program instructions, which enable system 400 to provide several features in accordance with the present invention.

The program instructions (and/or movie data) may be provided on removable storage unit 440, and the instructions may be read and provided by removable storage drive 437 to CPU 410. Floppy drive, magnetic tape drive, CD-ROM drive, DVD Drive, Flash memory, removable memory chip (PCMCIA Card, EPROM) are examples of such removable storage drive 437.

Removable storage unit 440 may be implemented using medium and storage format compatible with removable storage drive 437 such that removable storage drive 437 can read the program instructions. Thus, removable storage unit 440 includes a computer usable storage medium having stored therein the program instructions (and/or movie data).

CPU 410 may execute software instructions stored in RAM 420 to provide several features of the present invention. The software instructions may further use the movie data stored in removable storage unit 440 to cause the corresponding movie to be displayed in the case of RTVR 120. In the case of movie generator 110, the movie data may be caused to be generated by execution of the software instructions.

CPU 410 may contain multiple processing units, with each processing unit potentially being designed for a specific task. RAM 420 may receive instructions/movie data from secondary memory 430 using communication path 450. Data may be stored and retrieved from secondary memory 430 during the execution of the instructions/movie data.

Graphics controller 460 generates display signals (e.g., in RGB format) representing the movie to be played to display unit 130 based on movie data received from CPU 410. In the case of RTVR 120, graphics controller 460 may correspond to graphics controller 330. Display unit 130 contains a display screen to display the images defined by the display signals.

Thus, embodiments of the present invention are implemented using software instructions running (that is, executing) on CPU 410 to generate movie data and/or to display a movie represented by the movie data.

8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of playing a movie, said method comprising:
(a) specifying in a movie generator a plurality of attributes defining an object in said movie;
(b) specifying in said movie generator a plurality of transformation rules associated with said object, wherein each of said plurality of transformation rules indicates a change to one of said plurality of attributes, said object and said plurality of transformation rules together defining said movie;
(c) rendering a plurality of scenes in a video rendering system, wherein said plurality of scenes are rendered according to said plurality of attributes of said object and said plurality of transformation rules; and
(d) displaying said plurality of scenes on a display screen to play said movie.

2. The method of claim 1, further comprising specifying a slice plane, wherein said plurality of scenes are generated according to said slice plane.

3. The method of claim 2, further comprising specifying a transformation rule associated with said slice plane, wherein said plane is moved from one position to another according to said slice plane.

4. A method of generating a movie data representing a movie, said method comprising:
specifying a plurality of attributes defining an object in said movie; and
specifying a plurality of transformation rules associated with said object, wherein each of said plurality of transformation rules indicates a change to one of said plurality of attributes, said object and said plurality of transformation rules together defining said movie,
wherein data representing said plurality of attributes and said transformation rules is comprised in said movie data.

5. The method of claim 4, wherein said movie contains a plurality of objects.

6. The method of claim 4, wherein a plurality of instances of said movie are defined in said object, and a plurality of instantiation rules are associated with each of said plurality of instances.

7. The method of claim 4, wherein said object comprises an animation character.

8. The method of claim 4, wherein said object comprises one of a cube, a car, and a sphere, and said transformation rule comprises movement of said object according to an equation.

9. The method of claim 4, further comprising specifying a slice plane, wherein said movie data comprises data representing said slice plane also, wherein images displayed in said movie are generated according to said slice plane.

10. The method of claim 9, further comprising specifying a transformation rule associated with said slice plane, wherein said movie data comprises data representing said transformation rule.

11. A method of playing a movie, said method comprising:
receiving a movie data specifying a plurality of attributes defining an object, said movie data further specifying a plurality of transformation rules associated with said object, wherein each of said plurality of transformation rules indicates a change to one of said plurality of attributes, said object and said plurality of transformation rules together defining said movie;
rendering a plurality of scenes according to said plurality of attributes of said object and said plurality of transformation rules; and
displaying said plurality of scenes on a display screen to play said movie.

12. The method of claim 11, wherein said movie data specifies a slice plane, wherein said plurality of scenes are generated according to said slice plane.

13. The method of claim 12, wherein said movie data specifies a transformation rule associated with said slice plane, wherein said slice plane is moved from one position to another according to said slice plane.

14. The method of claim 13, further comprising compiling said movie data to generate an intermediate data, wherein rendering examines said intermediate data generate said plurality of scenes.

15. The method of claim 14, wherein said intermediate data represents a specific set of objects forming a specific scene according to said slice plane.

16. The method of claim 11, wherein said movie contains a plurality of objects.

17. The method of claim 11, wherein a plurality of instances of said object are defined in said movie, and a plurality of instantiation rules are associated with each of said plurality of instances.

18. The method of claim 11, wherein said object comprises an animation character.

19. The method of claim 11, wherein said object comprises one of a cube, a car, and a sphere, and said transformation rule comprises movement of said object according to an equation.

20. The method of claim 11, wherein said movie data is received from a local secondary storage or from a network.

21. A computer readable medium carrying one or more sequences of instructions for causing a video rendering system to play a video, said user application being executed in a system, wherein execution of said one or more sequences of instructions by one or more processors contained in said system causes said one or more processors to perform the actions of:
receiving a movie data specifying a plurality of attributes defining an object, said movie data further specifying a plurality of transformation rules associated with said object, wherein each of said plurality of transformation rules indicates a change to one of said plurality of attributes, said object and said plurality of transformation rules together defining said movie;
rendering a plurality of scenes according to said plurality of attributes of said object and said plurality of transformation rules; and
displaying said plurality of scenes on a display screen to play said movie.

22. The computer readable medium of claim 21, wherein said movie data specifies a slice plane, wherein said plurality of scenes are generated according to said slice plane.

23. The computer readable medium of claim 22, wherein said movie data specifies a transformation rule associated with said slice plane, wherein said slice plane is moved from one position to another according to said slice plane.

24. The computer readable medium of claim 23, further comprising compiling said movie data to generate an intermediate data, wherein rendering examines said intermediate data generate said plurality of scenes.

25. The computer readable medium of claim 24, wherein said intermediate data represents a specific set of objects forming a specific scene according to said slice plane.

26. The computer readable medium of claim 21, wherein said movie contains a plurality of objects.

27. The computer readable medium of claim 21, wherein a plurality of instances of said object are defined in said movie, and a plurality of instantiation rules are associated with each of said plurality of instances.

28. The computer readable medium of claim 21, wherein said object comprises an animation character.

29. The computer readable medium of claim 21, wherein said object comprises one of a cube, a car, and a sphere, and said transformation rule comprises movement of said object according to an equation.

30. The computer readable medium of claim 21, wherein said movie data is received from a local secondary storage or from a network.

31. A computer readable medium carrying one or more sequences of instructions for causing a movie generator to generate a movie data representing a movie, said user application being executed in a system, wherein execution of said one or more sequences of instructions by one or more processors contained in said system causes said one or more processors to perform the actions of:
specifying a plurality of attributes defining an object in said movie; and
specifying a plurality of transformation rules associated with said object, wherein each of said plurality of transformation rules indicates a change to one of said plurality of attributes, said object and said plurality of transformation rules together defining said movie,
wherein data representing said plurality of attributes and said transformation rules is comprised in said movie data.

32. The computer readable medium of claim 31, wherein said movie contains a plurality of objects.

33. The computer readable medium of claim 31, wherein a plurality of instances of said movie are defined in said object, and a plurality of instantiation rules are associated with each of said plurality of instances.

34. The computer readable medium of claim 31, wherein said object comprises an animation character.

35. The computer readable medium of claim 31, wherein said object comprises one of a cube, a car, and a sphere, and said transformation rule comprises movement of said object according to an equation.

36. The computer readable medium of claim 31, further comprising specifying a slice plane, wherein said movie data comprises data representing said slice plane also, wherein images displayed in said movie are generated according to said slice plane.

37. The computer readable medium of claim 36, further comprising specifying a transformation rule associated with said slice plane, wherein said movie data comprises data representing said transformation rule.

38. A movie generator for generating a movie data representing a movie, said movie generator comprising:
means for specifying a plurality of attributes defining an object in said movie; and
means for specifying a plurality of transformation rules associated with said object, wherein each of said plurality of transformation rules indicates a change to one of said plurality of attributes, said object and said plurality of transformation rules together defining said movie,
wherein data representing said plurality of attributes and said transformation rules is comprised in said movie data.

39. The movie generator of claim 38, wherein said movie contains a plurality of objects.

40. The movie generator of claim 38, wherein a plurality of instances of said movie are defined in said object, and a plurality of instantiation rules are associated with each of said plurality of instances.

41. The movie generator of claim 38, wherein said object comprises an animation character.

42. The movie generator of claim 38, wherein said object comprises one of a cube, a car, and a sphere, and said transformation rule comprises movement of said object according to an equation.

43. The movie generator of claim 38, further comprising means for specifying a slice plane, wherein said movie data comprises data representing said slice plane also, wherein images displayed in said movie are generated according to said slice plane.

44. The movie generator of claim 43, further comprising means for specifying a transformation rule associated with said slice plane, wherein said movie data comprises data representing said transformation rule.

45. A video rendering system for playing a movie, said video rendering system comprising:
means for receiving a movie data specifying a plurality of attributes defining an object, said movie data further specifying a plurality of transformation rules associated with said object, wherein each of said plurality of transformation rules indicates a change to one of said plurality of attributes, said object and said plurality of transformation rules together defining said movie;
means for rendering a plurality of scenes according to said plurality of attributes of said object and said plurality of transformation rules; and
means for displaying said plurality of scenes on a display screen to play said movie.

46. The video rendering system of claim 45, wherein said movie data specifies a slice plane, wherein said plurality of scenes are generated according to said slice plane.

47. The video rendering system of claim 46, wherein said movie data specifies a transformation rule associated with said slice plane, wherein said slice plane is moved from one position to another according to said slice plane.

48. The video rendering system of claim 47, further comprising means for compiling said movie data to generate an intermediate data, wherein rendering examines said intermediate data generate said plurality of scenes.

49. The video rendering system of claim 48, wherein said intermediate data represents a specific set of objects forming a specific scene according to said slice plane.

50. The video rendering system of claim 45, wherein said movie contains a plurality of objects.

51. The video rendering system of claim 45, wherein a plurality of instances of said object are defined in said movie, and a plurality of instantiation rules are associated with each of said plurality of instances.

52. The video rendering system of claim 45, wherein said object comprises an animation character.

53. The video rendering system of claim 45, wherein said object comprises one of a cube, a car, and a sphere, and said transformation rule comprises movement of said object according to an equation.

54. The video rendering system of claim 45, wherein said movie data is received from a local secondary storage or from a network.

55. A video rendering system for playing a movie, said video rendering system comprising:
a memory storing a movie data specifying a plurality of attributes defining an object, said movie data further specifying a plurality of transformation rules associated with said object, wherein each of said plurality of transformation rules indicates a change to one of said plurality of attributes, said object and said plurality of transformation rules together defining said movie;
a rendering module rendering a plurality of scenes according to said plurality of attributes of said object and said plurality of transformation rules; and
a display screen displaying said plurality of scenes to play said movie.

56. The video rendering system of claim 55, wherein said movie data specifies a slice plane, wherein said plurality of scenes are generated according to said slice plane.

57. The video rendering system of claim 56, wherein said movie data specifies a transformation rule associated with said slice plane, wherein said slice plane is moved from one position to another according to said slice plane.

58. The video rendering system of claim 57, further comprising a pre-processing block compiling said movie data to generate an intermediate data, wherein rendering examines said intermediate data generate said plurality of scenes.

59. The video rendering system of claim 58, wherein said intermediate data represents a specific set of objects forming a specific scene according to said slice plane.

60. The video rendering system of claim 55, wherein said movie contains a plurality of objects.

61. The video rendering system of claim 55, wherein a plurality of instances of said object are defined in said movie, and a plurality of instantiation rules are associated with each of said plurality of instances.

62. The video rendering system of claim 55, wherein said object comprises an animation character.

63. The video rendering system of claim 55, wherein said object comprises one of a cube, a car, and a sphere, and said transformation rule comprises movement of said object according to an equation.

64. The video rendering system of claim 55, wherein said movie data is received from a local secondary storage or from a network.
